(19) United States
(12) Patent Application Publication
(10) Pub. No.: US 2021/0293439 A1
(43) Pub. Date: Sep. 23, 2021

(54) AIR QUALITY MONITORING AND CONTROL BY A DEMAND CONTROL VENTILATION SYSTEM

(71) Applicant: Melink Solar & Geo, Inc., Milford, OH (US)

(72) Inventors: Stephen K. Melink, Cincinnati, OH (US); Stephen Hamstra, Zeeland, MI (US)

(21) Appl. No.: 17/204,537

(22) Filed: Mar. 17, 2021

Related U.S. Application Data
(60) Provisional application No. 62/991,900, filed on Mar. 19, 2020.

(51) Int. Cl. F24F 11/77; F24F 11/46

(52) U.S. Cl. CPC F24F 11/77; F24F 2110/10; F24F 11/46

(57) ABSTRACT

A demand control ventilation system is disclosed. Sensors positioned in the building measure a corresponding air quality parameter. Each air quality parameter is indicative as to a current demand required for ventilation of the building based on human activity conducted by occupants present in the building. A controller monitors each air quality parameter to determine whether any air quality parameter deviates beyond the corresponding air quality parameter threshold. The controller activates a graduated action when each air quality parameter deviates beyond the corresponding air quality parameter threshold to automatically adjust the ventilation of the building to maintain the current demand of the ventilation within the current demand threshold. The current demand threshold is a ventilation level of the ventilation of the building that satisfies the current demand based on human activity and prevents unnecessary energy consumption to satisfy the current demand.

### CROSS-REFERENCE TO RELATED APPLICATIONS

The present application is a U.S. Nonprovisional Application which claims the benefit of U.S. Provisional Application No. 62/991,900 filed on Mar. 19, 2020 which is incorporated herein by reference in its entirety.

### BACKGROUND

### Field of Disclosure

The present disclosure generally relates to a demand control ventilation system and specifically to air quality parameter monitoring by the demand control ventilation system and automatic adjustment to the air ventilation of a building in response to the air quality parameter monitoring by the demand control ventilation system.

### Related Art

Conventional buildings include separate indoor exhaust and outdoor air intake systems that may easily cause an imbalance in that the indoor exhaust system may be operating significantly more than the outdoor air intake system and/or the outdoor air intake system may be operating significantly more than the indoor exhaust system. Such a conventional separation in the indoor exhaust and outdoor air intake systems may result in significant air pressure issues as well as the disconnect between the indoor exhaust system and the outdoor air intake system may result in one or the other being manually deactivated when each should be activated. Further, significant and unnecessary high energy costs may be incurred when the outdoor temperatures being low in the winter or high in the summer significantly varies from the indoor temperature of the building. Thus, the lack of synergy in conventional separate indoor exhaust and outdoor air intake systems results in unnecessary energy consumption.

Conventional buildings may include a conventional energy recovery ventilator (ERV). Rather than have separate indoor exhaust and outdoor air intake systems, the conventional ERV connects the exhaust stream to the incoming fresh air stream via a heat exchanger or heat wheel. In doing so, the conventional ERV may decrease the energy consumption of the building that is devoted to ventilation by pre-conditioning the incoming fresh air with the outgoing exhaust air. Thus, the incoming fresh air is not pre-conditioned independently from the outgoing exhaust air but rather the outgoing exhaust air is used to pre-condition the incoming fresh air thereby decreasing the energy consumption for ventilation.

However, conventional ERVs still unnecessarily consume energy in the ventilation of buildings. Typically, conventional ERVs operate at constant speeds in that the ventilation of the building is not automatically adjusted as the demand for ventilation in the building is adjusted. Typically, conventional ERVs operate at two speeds. The first speed is a constant speed that the conventional ERV increases the ventilation based on a pre-determined time slot when occupancy of the building is predicted to increase, such as 7:30 am, when occupants begin to enter the building for the workday. The conventional ERV may then maintain that constant speed of the ventilation until a pre-determined time slot when occupancy of the building is predicted to decrease, such as 6:30 pm. The conventional ERV may then decrease the speed of ventilation to a second speed that is significantly lower than the first speed of ventilation during occupancy due to the lack of occupancy of the building during off hours. However, often times during the occupancy hours, the ventilation may be significantly decreased due to the lack of demand by occupants in the building. In doing so, the operation of the ventilation at the first speed may be unnecessary throughout many portions of the day thereby resulting in unnecessary energy consumption for the ventilation.

### BRIEF DESCRIPTION OF THE DRAWINGS/FIGURES

Embodiments of the present disclosure are described with reference to the accompanying drawings. In the drawings, like reference numerals indicate identical or functionally similar elements. Additionally, the left most digit(s) of a reference number typically identifies the drawing in which the reference number first appears.

FIG. 1 illustrates a block diagram of a demand control ventilation configuration such that a controller may automatically adjust a demand control ventilation system based on air quality parameters monitored by sensors positioned throughout a building; and

FIG. 2 illustrates a block diagram of demand control ventilation configuration where the demand control ventilation system (DVCS) controller monitors various air quality parameters associated with the current demand of the required of the ventilation of the building based on the human activity of the occupants of the building.

### DETAILED DESCRIPTION OF THE PRESENT DISCLOSURE

The following Detailed Description refers to accompanying drawings to illustrate exemplary embodiments consistent with the present disclosure. References in the Detailed Description to “one exemplary embodiment,” an “exemplary embodiment,” an “example exemplary embodiment,” etc., indicate the exemplary embodiment described may include a particular feature, structure, or characteristic, but every exemplary embodiment may not necessarily include the particular feature, structure, or characteristic. Moreover, such phrases are not necessarily referring to the same exemplary embodiment. Further, when a particular feature, structure, or characteristic may be described in connection with an exemplary embodiment, it is within the knowledge of those skilled in the art(s) to effect such feature, structure, or characteristic in connection with other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the present disclosure. Therefore, the Detailed Description is not meant to limit the present disclosure. Rather, the scope of the present disclosure is defined only in accordance with the following claims and their equivalents.

Embodiments of the present disclosure may be implemented in hardware, firmware, software, or any combination thereof. Embodiments of the present disclosure may also be implemented as instructions applied by a machine-readable medium, which may be read and executed by one or more processors. A machine-readable medium may include any mechanism for storing or transmitting information in a form readable by a machine (e.g., a computing device). For example, a machine-readable medium may include read only memory (“ROM”), random access memory (“RAM”), magnetic disk storage media, optical storage media, flash memory devices, electrical optical, acoustical or other forms of propagated signals (e.g., carrier waves, infrared signals, digital signals, etc.), and others. Further firmware, software routines, and instructions may be described herein as performing certain actions. However, it should be appreciated that such descriptions are merely for convenience and that such actions in fact result from computing devices, processors, controllers, or other devices executing the firmware, software, routines, instructions, etc.

For purposes of this discussion, each of the various components discussed may be considered a module, and the term “module” shall be understood to include at least one software, firmware, and hardware (such as one or more circuit, microchip, or device, or any combination thereof), and any combination thereof. In addition, it will be understood that each module may include one, or more than one, component within an actual device, and each component that forms a part of the described module may function either cooperatively or independently from any other component forming a part of the module. Conversely, multiple modules described herein may represent a single component within an actual device. Further, components within a module may be in a single device or distributed among multiple devices in a wired or wireless manner.

The following Detailed Description of the exemplary embodiments will so fully reveal the general nature of the present disclosure that others can, by applying knowledge of those skilled in the relevant art(s), readily modify and/or adapt for various applications such exemplary embodiments, without undue experimentation, without departing from the spirit and scope of the present disclosure. Therefore, such adaptations and modifications are intended to be within the meaning and plurality of equivalents of the exemplary embodiments based upon the teaching and guidance presented herein. It is to be understood that the phraseology or terminology herein for the purpose of description and not of limitation, such that the terminology or phraseology of the present specification is to be interpreted by those skilled in the relevant art(s) in light of the teachings herein.

### System Overview

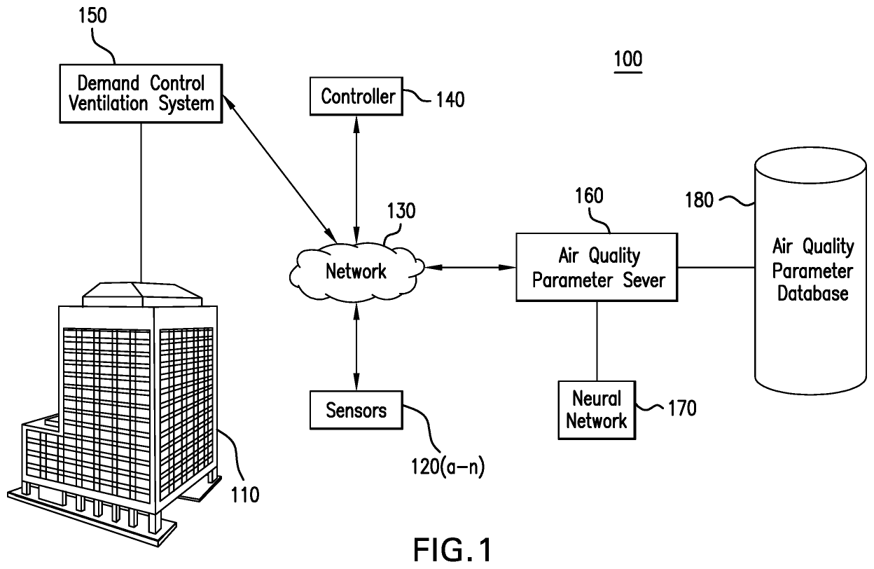

FIG. 1 illustrates a block diagram of a demand control ventilation configuration such that a controller may automatically adjust a demand control ventilation system based on air quality parameters monitored by sensors positioned throughout a building. A demand control ventilation configuration 100 includes a building 110. The building 110 includes a demand control ventilation system 150 as well as sensors 120(a-n) positioned throughout the building 110. A controller 140 may automatically adjust the demand control ventilation system 150 to adjust the ventilation of the building based on air quality parameters measured by a plurality of sensors 120(a-n) positioned throughout the building 110 where n is an integer greater than one. An air quality parameter server 160 may gather data with regard to how the controller 140 automatically adjusts the demand control ventilation system 150 based on the numerous different air quality parameters continuously measured by the sensors 120(a-n) and store such data in air quality parameter database 170 to incorporate into a neural network 170.

Ventilation of commercial buildings 110 often times represents 20-30% of the total HVAC system load for commercial buildings 110. Such a significant commitment of energy consumption to the ventilation of commercial buildings provides a significant opportunity to decrease the energy consumption committed to the ventilation of commercial buildings 110. Rather than ventilating commercial buildings 110 based on the square footage of the building 110 and/or based on setting the ventilation at a constant speed due to extended time periods of increased occupation in the building 110, such as during peak business hours, the controller 140 may monitor the different air quality parameters measured by each of the different sensors 120(a-n) and may automatically adjust the demand control ventilation system 150 in a manner that the ventilation of the building 110 is adjusted based on the current demand of the occupants occupying the building 110 and not based on the square footage of the building 110 and/or a constant speed due to the known extended period of time of peak occupancy.

Conventional demand control ventilation systems may be equipped with an energy recovery ventilator (ERV) in that the ERV connects the exhaust air stream with the incoming fresh air stream via a heat exchanger or heat wheel. In doing so, the ERV decreases energy that is consumed during ventilation by pre-conditioning the incoming fresh air with the outgoing exhaust air. However, conventional demand control ventilation systems that even are equipped with an ERV still unnecessarily consume energy when ventilating the building 110. Typical conventional demand control ventilation systems operate based on a fixed demand that is determined by the designer in that the fan speed committed to ventilation by the conventional demand control ventilation systems increases significantly and operates at a constant speed during an extended time period when there is a known increased occupancy in the building 110, such as during peak business hours. The conventional demand control ventilation system then significantly decreases the fan speed and operates at a constant speed that committed to ventilation by the conventional demand control ventilation system during an extended time period when there is a known decreased occupation in the building 110, such as during off business hours.

Simply increasing the fan speed committed to ventilation to operate at a constant speed during an extended time period when there is a known increased occupation in the building 110 and then decreasing the fan speed committed to ventilation at a constant speed during an extended time period when there is a known decreased occupation in the building 110 still results in significant energy consumption committed to ventilation that is unnecessary. Often times, the designer of the conventional demand control ventilation system sets the extended time period that the fan speed committed to ventilation is to operate at the increased constant speed as well as determining the constant speed at the increased level at levels that ensures that the occupants of the building experience adequate ventilation regardless of the demand in ventilation by the occupants.

For example, the designer may set the extended time period that the fan speed committed to ventilation is to operate at the increased speed to match the occupied start time of the HVAC system which is when the first occupants may arrive at the building 110 at the start of the business day, such as at 7:30 am. Typically, the amount of occupants arriving at the building at 7:30 am is significantly less than the amount of occupants arriving at the building at 8:00 am and then 9:00 am and so on. However, the designer of the conventional demand control ventilation system cannot risk not having sufficient ventilation for the occupants arriving at 7:30 am by delaying the increase in the fan speed committed to ventilation to 10:00 am when typically the maximum amount of occupants in the building 110 have arrived for the business day. Rather than adjusting the fan speed committed to ventilation based on occupant demand, the designer cannot risk denying the occupants from having sufficient ventilation at 7:30 am and therefore must unnecessarily ramp up the fan speed committed to ventilation at 7:30 am to ensure that the minimum demand throughout the extended period of time of the business day is satisfied at all times. Regardless as to the quantity of occupants that actually arrive at the building 110 as well as the demand of ventilation of the occupants, the designer of the conventional demand control ventilation system may automatically increase the speed of the fans committed to ventilation at 7:30 am.

Further on the transitioning from operating the fans at a constant increased speed committed to ventilation during the extended period of time due to known peak occupancy to operating the fans at a constant decreased speed committed to ventilation during the extended period of time due to known decreased occupancy, designers again set the transition to the time when the designers are confident that the known decrease in occupancy has been reached. For example, the designer may transition the fans from operating at the constant increased speed which begins at 7:30 am to continuously operate at the constant increased speed until 7:30 pm which is when the designer is confident that the occupancy of the building 110 has significantly decreased due to the end of the business day. Although peak departure time for occupants leaving the building 110 may be 5:00 pm when the greatest quantity of occupants may be departing the building 110, a lesser quantity of occupants may continue to occupy the building 110 until 7:30 pm. Rather than adjusting the fan speed committed to ventilation based on occupant demand, the designer cannot risk denying the occupants from having sufficient ventilation at 7:00 pm and therefore must unnecessarily maintain the fan speed committed to ventilation up until 7:30 pm to ensure the minimum demand throughout the extended period time of the business day is satisfied at all times. Regardless of the quantity of occupants that actually depart the building 110 as well as the demand of ventilation of occupants, the designer of the conventional demand control ventilation system may automatically maintain the increased speed of the fans committed to ventilation until 7:30 pm.

Further, significant unnecessary energy consumption committed to ventilation may also occur due to the increased constant speed committed to ventilation during the extended period of time due to known peak occupancy. Rather than adjusting the fan speed committed to ventilation based on the demand of the occupants, the designer of the conventional demand control ventilation system typically ensures that any demand due to occupancy that occurs during known peak occupancy is satisfied by having fan speed committed to ventilation to operate at a constant level throughout the period of time of known peak occupancy. The designer of the conventional demand control ventilation system cannot risk providing inadequate ventilation during periods of peak demand and thus must maintain the fan speed committed to ventilation at a constant level throughout the period of time of known peak occupancy to ensure that the periods of peak demand are satisfied. For example, the fan speed committed to ventilation may automatically increase to 100% capacity at 7:30 am and then run at 100% capacity until 7:30 pm. Although the demand of the ventilation by the occupants may be significantly less than requiring the fans to run at 100% capacity throughout the day, such as running at as low as 10% during periods of decreased demand, the designer of the conventional demand control ventilation systems cannot risk that any peak demand throughout the period of time of known peak occupancy is not satisfied throughout the extended period of time.

For example, there may be durations of time throughout the day where the odors present in the bathrooms are at an increased level requiring an increase in fan speed committed to ventilation to adequately remove the odors at increased levels such as requiring the fan speed to operate at 100% capacity. However, the periods of time where the odors are at increased levels only occur during peak times throughout the period of time of known peak occupancy thereby only requiring fans committed to ventilation to operate at an increased speed for those peak times throughout the day, such as requiring the fan speed to operate at 100% capacity during those peaks of odors of increased levels. The remaining portions of the period of time of known peak occupancy may require the fan speed to operate at significantly less capacity when peaks of odors are not at increased levels, such as operate as low as at 10% to 20% capacity during periods of decreased demand.

Rather than have the fan speed committed to ventilation increase for a period of time when there are odors at increased levels, the designers of the conventional demand control ventilation system have the fan speed operate at a constant fan speed at an increased capacity that is sufficient to remove any odors at increased level any time throughout the extended period of time of known peak occupancy regardless of the odors at the increased level. In such an example, the fan speed committed to ventilation may operate at 100% capacity throughout the extended period of time of peak occupancy to ensure that any odors are adequately removed at any time throughout the time of peak occupancy when the fan speed may be significantly decreased, such as to 10% to 20% capacity, during periods of time when the odors are not increased levels thereby resulting in significant power consumption committed to ventilation that is unnecessary.

American Society of Heating, Refrigerating and Air-Conditioning Engineers (ASHRAE) standards provide overall regulation and/or guidance with regard to ensuring that buildings have adequate fresh air to replace the CO2 that naturally builds up over time in the buildings due to occupancy by occupants who are emitting CO2 as they inhale in oxygen in the building. As the CO2 and odors are generated in the building by the occupants, ASHRAE standards require that such CO2 and odors be exhausted from the buildings and replaced with adequate fresh air that is located outside the building. In doing so, adequate fresh air outside the building is ventilated into the building and existing air inside the building is exhausted out.

ASHRAE standards provide such overall regulation and/or guidance as to the ventilation of fresh air outside the building and exhausting air inside the building based on a CO2 level of the building. The ASHRAE standards correspond the CO2 level of the building with the quantity of occupants located in the building and thereby provide a metric as to the exhaust required to remove the CO2 from the building and replenish with fresh air from outside the building. Typically, such a CO2 level is conventionally detected by a single CO2 sensor positioned in a main area of the building such as a main office. That single CO2 level measured by the CO2 sensor is insufficient to account for other demands on the exhaust such as increased odors located in the bathrooms. Thus, typically, the designer of the conventional demand control ventilation system that incorporates a single CO2 sensor positioned in the building still elevates the fan speed committed to ventilation to a constant increased speed during the extended period of time for peak occupancy to still ensure that any peak times of peak demand such as removing odors from the bathrooms is accommodated by the increased fan speed. The designer cannot risk lowering the fan speed simply based on the CO2 level measured by a single CO2 sensor as such data is still insufficient to accommodate for peak levels of peak demand of ventilation such as when increased levels of odors are present in the bathrooms.

Further, the replacing of exhausted air that includes CO2 and odors from the building with fresh air outside the building results in an increase in fresh air that needs to be conditioned with the temperature of the fresh air outside the building significantly varying from the inside temperature of the building. For example, the temperature of the fresh air outside the building varies significantly from the inside temperature during the summer months when the fresh air outside the building is significantly hotter than the inside air of the building and during the winter months when the fresh air outside the building is significantly cooler than the inside air of the building. As a result, increased energy is consumed in the ventilation of the summer months and the winter months due to the increased conditioning required to either cool the hot outside air during the summer months and/or warm the cool outside air during the cold months. In doing so, the unnecessary ventilation of the outside air into the building by the increased and constant fan speed during the extended period of time during peak occupancy further compounds the amount of unnecessary energy consumed due to the increase in outside air that then needs to be conditioned when ventilated inside the building simply due to the conventional demand control ventilation system running at an increased and constant fan speed to ensure that any demand throughout the period of time of peak occupancy is satisfied.

Rather than simply setting the fan speed committed to ventilation at an increased and constant fan speed to ensure that any type of demand on ventilation is adequately satisfied throughout the extended period of time of peak occupancy, the controller 140 may automatically adjust the demand control ventilation system 150 based on the different air quality parameters measured by the different sensors 120(a-n) positioned throughout the building 110. The automatic adjustment of the demand control ventilation system 150 by the controller 140 based on the air quality parameters measured by the different sensors 120(a-n) enables the controller 140 to adjust the demand ventilation control system 150, such as the fan speed committed to ventilation, damper control, any other variable volume system, and so on, based on the current demand of the occupants of the building rather than setting the such ventilation at increased and constant levels to ensure that a peak demand when hit is satisfied. Rather, the controller 140 may decrease the fan speed committed to ventilation, damper control, any other variable volume system, and so on when the demand of the occupants does not require an increased fan speed committed to ventilation and so on and then increase the fan speed committed to ventilation and so only when the occupant demand requires such an increase and then decrease when the occupant demand no longer requires the increase.

A demand control ventilation system 150 automatically adjusts ventilation of a building 110 based on a plurality of air quality parameters that are monitored throughout the building 110. A plurality of sensors 120(a-n) are positioned in the building 110 and each sensor 120(a-n) measures a corresponding air quality parameter that each sensor is capable of measuring. Each air quality parameter is indicative as to a current demand required of the ventilation of the building 110 based on human activity conducted by occupants in the building 110. A controller 140 monitors each air quality parameter measured by each corresponding sensor 120(a-n) to determine whether at least one air quality parameter deviates beyond at least one corresponding air quality parameter threshold. The controller 140 then activates at least one graduated action when each air quality parameter deviates beyond the at least one corresponding air quality parameter threshold to automatically adjust the ventilation of the building 110 to maintain the current demand of the ventilation within a current demand threshold. The current demand threshold is a ventilation level of the ventilation of the building 110 that satisfies the current demand based on human activity and prevents unnecessary energy consumption to satisfy the current demand.

The controller 140 may automatically adjust the demand control ventilation system 150 based on the current demand required on the ventilation of the building 110 based on human activity conducted by the occupants of the building. The current demand is the demand required of the ventilation by the occupants of the building in real-time. Such demand is represented based on the different air quality parameters measured by the sensors 120(a-n). As each of the different air quality parameters indicate that ventilation is required to address such air quality parameters, such current demand of the ventilation based on the human activity of the occupants of the building 110 indicates that the demand control ventilation system 150 is needed to execute graduated actions to satisfy the current demand of the ventilation as indicated by the different air quality parameters. In doing so, the demand control ventilation system 150 only executes the graduated actions instructed by the controller 140 to satisfy the current demand of the ventilation as indicated by the different air quality parameters and then ceases the execution of the graduated actions when such graduated actions are no longer necessary to satisfy the current demand of ventilation.

In doing so, numerous sensors 120(a-n) are positioned throughout the building 110 to measure numerous different air quality parameters throughout the building 110 in real-time as the human activity of the occupants of the building 110 representing the current demand of ventilation required by the occupants varies in real-time. Rather than having a single CO2 sensor positioned in a single location of the building that simply measures the CO2 level of the single location of the building, numerous sensors 120(a-n) are positioned throughout numerous locations of the building 110 with each of the numerous sensors 120(a-n) measuring different air quality parameters throughout the building 110 in real-time. The single CO2 sensor positioned at a single location of the building 110 simply measures the CO2 level of the single location of the building 110 that is only indicative as to the quantity of people possibly excreting CO2 in the single location of the building 110. The CO2 level of the single location of the building 110 is insufficient for the controller 140 to adequately adjust the demand control ventilation system 150 in real-time to satisfy the current demand of ventilation by the occupants of the building 110 while doing so without unnecessarily consuming energy.

Rather, the numerous sensors 120(a-n) positioned throughout the building 110 measure numerous different air quality parameters that indicate the current demand of ventilation of the occupants throughout the building 110 rather than in a single location. For example, in addition to the CO2 sensor positioned in a single location of the building 110 to measure the CO2 level of the single location of the building, numerous CO2 sensors may be positioned throughout the building so that the quantity of people in real-time throughout numerous locations of the building may be correlated from numerous different CO2 levels measured from numerous different locations of the building 110. In addition, occupancy sensors may be positioned in the different bathrooms throughout the building 110. Typically when occupants enter the bathrooms, the likelihood of odors generated in the bathrooms increases and when occupants leave the bathrooms, the likelihood of odors generated in the bathrooms decreases. In addition, humidity sensors may be positioned throughout the building 110 such that when showers are activated an increase in the ventilation is required to remove the excess humidity caused by the showers. In addition, sulfur dioxide sensors may be positioned in the bathrooms as well as an increase in the sulfur dioxide levels in the bathrooms may be indicative as to an increase odors requiring an increase in the ventilation required to remove the odors.

Rather than simply setting the fan speed committed to ventilation and so on at a constant increased speed to ensure the numerous different air quality parameter threshold are satisfied at all times during the extended period of time of peak occupancy, the controller 140 may automatically adjust the demand control ventilation system 150 to address each air quality parameter when each air quality parameter deviates from the air quality parameter threshold in real-time. In doing so, the controller 140 may automatically adjust the demand control ventilation system 150 based on the current demand of the ventilation that is presented to the controller 140 based on the numerous sensors 120(a-n) that are each measuring numerous air quality parameters. The controller 140 may then address each air quality parameter that deviates from the corresponding air quality parameter threshold as needed thereby limiting energy consumption devoted to the ventilation of the building to energy that is consumed when needed based on the current demand required of the ventilation based on the occupants of the building 110.

For example, rather than increasing to 100% of fan speed capacity simply when the clock strikes 7:30 am indicating the beginning of increased occupancy of the building 110 and/or a CO2 level measured by a single CO2 sensor that indicates increased occupants in the building 110, the controller 140 may automatically increase the fan speed to 10% capacity when the occupancy sensor positioned in each bathroom indicates occupants are in the bathroom in anticipation of an increased requirement in ventilation. The controller 140 may then automatically increase the fan speed to 20% capacity when the sulfur dioxide sensors positioned in each bathroom indicates an increase in odors in addition to the occupancy sensor positioned in each bathroom indicating occupants are in the bathroom as the increase in odors is indicative of the current demand of the required ventilation by the occupants to be increased. The controller 140 may then automatically increase the fan speed to 30% capacity when the humidity sensors positioned in the showers indicate that the showers have been activated and that the increase in humidity from the activated showers is indicative of the current demand of required ventilation by the occupants to be increased. The controller 140 may then respectively decrease the fan speed committed to ventilation when the humidity levels have decreased indicating that the showers are no longer activated, the sulfur dioxide sensors indicate a decreased level of odors, and the occupancy sensors indicate a decreased level of occupancy in the bathrooms.

As noted above, the sensors 120(a-n) may be positioned in the building 110 with each sensor 120(a-n) measuring a corresponding air quality parameter that each sensor 120(a-n) is capable of measuring. Each air quality parameter may be indicative as to a current demand required of the ventilation of the building 110 based on human activity conducted by occupants present in the building 110. Each air quality parameter measured by the sensors 120(a-n) may provide insight as to the activity of the occupants of the building 110 in real-time that thereby indicates whether the ventilation of the building 110 as provided by the demand control ventilation system 150 is to be adjusted accordingly by the controller 140 based on the different air quality parameters. For example, temperature sensors positioned throughout the building 110 may measure the air quality parameter of temperature that is indicative to a corresponding level of heat present in different locations of the building 110. As the air quality parameter of temperature increases, such an increase is indicative that the current demand of required ventilation of the building 110 based on the activity of the occupants present in the building 110 in real-time is also increasing. The controller 140 may then automatically adjust the demand control ventilation system 150 in real-time to accommodate the increase in the air quality parameter of temperature.

The sensors 120(a-n) may be positioned throughout the building 110 to measure air quality parameters indicative of the current demand of ventilation by occupants inside the building 110 as well as sensors 120(a-n) positioned in the environment outside the building 110 to provide air quality parameters with regard to the air outside located outside the building 110 that may be ventilated inside the building 110 when the air inside the building 110 is exhausted out. The sensors 120(a-n) may be any type of sensor that is capable of measuring in real-time any type of air quality parameter. For example the sensors 120(a-n) may include but are not limited to temperature sensors, CO2 sensors, occupancy sensors, humidity sensors, sulfur dioxide sensors, infrared sensors, motion sensors, heat detection sensors, pressure sensors, and/or any other type of sensor that is capable of measuring air quality parameters that are indicative as to the current demand of required ventilation of the building 110 based on the human activity of the occupants of the building 110 that will be apparent to those skilled in the relevant art(s) without departing from the spirit and scope of the disclosure.

The air quality parameters measured by the sensors 120(a-n) may be any type of parameter that is indicative as to the current demand of required ventilation by the human activity conducted by the occupants of the building 110. For example, the air quality parameters may include but are not limited to temperature, CO2, occupancy, humidity, sulfur dioxide, odor levels, motion, heat, pressure, and/or any other type of air quality parameter that is indicative as to the current demand of required ventilation by the human activity conducted by the occupants of the building that will be apparent to those skilled in the relevant art(s) without departing from the spirit and scope of the disclosure.

As noted above, the controller 140 may monitor each air quality parameter be each corresponding sensor to determine whether at least one air quality parameter deviates beyond at least one corresponding air quality parameter threshold. Each corresponding each air quality parameter threshold is the threshold for each air quality parameter that when deviated is indicative that the current demand of required ventilation based on the human activity conducted by occupants of the building 110 requires an automatic adjustment in the ventilation by the demand control ventilation system 150 as instructed by the controller 140 to accommodate for the air quality parameter that has deviated from the corresponding air quality parameter threshold. For example, the air quality parameter of the humidity parameter may have a corresponding humidity parameter threshold that when the humidity parameter measured by the corresponding humidity sensor increases above the humidity parameter threshold is indicative that the humidity level of that particular location of the building 110 has increased to a level that requires the controller 110 to automatically increase the fan speed committed to ventilation of the demand control ventilation system 150 to decrease the humidity level to below the humidity parameter threshold. In doing so, the controller 110 automatically addresses the current demand required of the ventilation of the building 110 by increasing the fan speed committed to ventilation until the humidity parameter is decreased below the humidity parameter threshold. The controller 140 may then automatically adjust the fan speed committed to ventilation to decrease the fan speed as the increased fan speed is no longer necessary to address the humidity parameter that has increased above the humidity parameter threshold.

As noted above, the controller 140 may activate at least one graduated action when each air quality parameter deviates beyond the at least one corresponding air quality parameter threshold to automatically adjust the ventilation of the building 110 to maintain the current demand of the ventilation within a current demand threshold. The current demand threshold is a ventilation level of the ventilation of the building that satisfies the current demand based on human activity and prevents unnecessary energy consumption to satisfy the current demand. Each graduated action activated by the controller 140 may be an action executed by the demand control ventilation system 150 to that addresses the air quality parameter that has deviated from the air quality parameter threshold. For example, the graduated action may be increasing the fan speed of the fans committed to ventilation of the demand control ventilation system 150 to decrease the CO2 parameter level measured of the air quality parameter of CO2 by different CO2 sensors to exhaust the CO2 in the building 110 until the CO2 parameter has decreased below the CO2 parameter threshold.

As noted above, the demand control ventilation system 150 may include a plurality of fans committed to ventilation as well as include an ERV as well as include dampers as well as exhausting the air inside the building 110 to the outside and ventilating air outside the building 110 to inside the building 110 as well as conditioning such outdoor air ventilated in with the indoor air that is being exhausted out and/or any other variable volume system that the demand control ventilation system 150 may have activated by the controller 140 to adjust the ventilation of the building 110. The graduated actions activated by the controller 140 and executed by the demand control ventilation system 150 may include any type of action as executed by the fans, the ERV, the dampers, and/or any other variable volume system included in the demand control ventilation system 150 that may be activated by the controller to adjust the ventilation of the building 110 to adjust air quality parameters to be within the corresponding air quality parameter threshold that will be apparent to those skilled in the relevant art(s) without departing from the spirit and scope of the disclosure.

The current demand threshold is a ventilation level of the ventilation of the building 110 that satisfies the current demand based on human activity and prevents unnecessary energy consumption to satisfy the current demand. As the controller 140 automatically adjusts the demand control ventilation system 150 to execute graduated actions to address each air quality parameter that deviates from the corresponding air quality parameter threshold in real-time, the overall current demand threshold of the building 110 is maintained due to the customized adjustment of the demand control ventilation system 150 to execute the graduated actions necessary to address each air quality parameter that deviates from the corresponding air quality parameter thresholds as each air quality parameter deviates from the corresponding air quality parameter threshold in real-time.

In doing so, the controller 140 is able to maintain the current demand threshold of the ventilation level of the ventilation of the building 110 to satisfy the current demand based the human activity of the occupants in real-time but does so by limiting the graduated actions executed by the demand control ventilation system 150 to those graduated actions necessary to maintain the air quality parameters within their air quality parameter thresholds. The controller 140 also limits the duration of such graduated actions to the duration necessary to maintain the air quality parameters within their corresponding air quality parameter thresholds. Thus, the current demand of the required ventilation based on the human activity of the occupants of the building 110 is maintained within the current level threshold but does so without unnecessary energy consumption to satisfy the current demand. Real-time is the state of the air quality parameters as monitored by the controller 140 as triggered by the human activity of the occupants of the building 110 and then the execution of graduated actions to address the air quality parameters that deviate from the corresponding air quality parameter thresholds to maintain the air quality parameters within the corresponding air quality parameter thresholds.

The controller 140 may refrain from activating each graduated action when each corresponding air quality parameter is maintained within the corresponding air quality parameter threshold to prevent the graduated action from being activated when the current demand required of the ventilation of the building does not require the activation of each graduated action to maintain the current demand of the ventilation within the current demand threshold thereby preventing unnecessary energy consumption to satisfy the current demand. The controller 140 refrains from activating any unnecessary graduated action when the corresponding air quality parameters do not require any graduated actions to maintain the air quality parameters within the air quality parameter thresholds. For example, the controller 140 may refrain from increasing the fan speed to 40% capacity when the humidity parameter is within the humidity parameter threshold and may simply increase the fan speed to 10% capacity when the occupancy parameter of the bathrooms exceeds the occupancy parameter threshold.

Similarly, the controller 140 may activate each graduated action when each corresponding air quality parameter deviates beyond the corresponding air quality parameter threshold and maintains each graduated action in a deactivated state when each corresponding air quality parameter that is maintained within the corresponding air quality parameter threshold to limit activation of each graduated action to each graduated action that is required to maintain the current demand of the ventilation within the current demand threshold and to prevent unnecessary energy consumption by unnecessary activation of graduated actions. As HVAC systems activate heating and/or cooling based on a set temperature of a thermostat that is deviated from, the controller 140 may limit the activation of graduated actions to those graduated actions required to address only those air quality parameters that have deviated from their corresponding air quality parameter thresholds when such air quality parameters have deviated from those air quality parameter thresholds. Unlike HVAC systems, the controller 140 is monitoring numerous air quality parameters as measured by numerous different sensors 120(a-n) rather than a single parameter and activating graduated actions and/or maintaining the deactivated graduated actions in real-time based on the air quality parameters relative to the corresponding air quality parameter thresholds.

For example, a sequence of operation by the controller 140 of the demand control ventilation system 150 may be the following. The controller 140 activates the graduated action of the demand control ventilation system 150 activating the fans at a speed of 20% capacity at 7:30 am which is the beginning of when occupants may begin to arrive at the building 110. Two out of ten restroom sensors 120(a-n) may then pick up motion from occupants in the restrooms. The controller 140 may then activate the graduated action of the demand control ventilation system 150 increasing the fans at a speed of 50% capacity. After fifteen minutes, the two restroom sensors 120(a-n) no longer measure motion and the controller 140 may then have the demand control ventilation system 150 decrease the fans at a speed of 20% capacity. An occupant then takes a shower and one out of two humidity sensors 120(a-n) measure RH>75%. The controller 140 then activates the graduated action of the demand control ventilation system 150 to increase the fan speed to 50% capacity. The humidity sensors 120(a-n) then measure that the RH is less than 60%.

The controller 140 then have the demand control ventilation system 150 decrease the fans to a speed of 20% capacity. At 11:00 am the different CO2 sensors 120(a-n) measure the CO2 level increase above 800 ppm due to the amount of people working in the building 110 over time. The controller 140 activates the graduated action of the demand control ventilation system 150 increasing the fans to a fan speed that proportionally varies between 20% and 100% capacity as the CO2 level varies between 800 pppm and 1000 ppm. At 4:00 pm the different CO2 sensors 120(a-n) measure that the CO2 level decreases below 800 ppm due to people beginning to leave the building 110. The controller 140 then may decrease the speed of the fans to 20% capacity. At 5:00 pm, the controller 140 may execute the graduated action of the demand control ventilation system 150 deactivating the fans. At 5:30 pm, one of the ten motion sensors 120(a-n) may detect motion in the restroom. The controller 140 may then activate the graduated action of the demand control ventilation system 150 increasing the fan speed to 30% capacity until motion is no longer detected.

The streaming of the air quality parameters as measured by the sensors 120(a-n) in real-time may be wirelessly streamed to the controller 140 via network 130 such that the controller 140 may monitor the air quality parameters as measured by the sensors 120(a-n) wirelessly in real-time. Further, the controller 140 may then activate the appropriate graduated actions to be executed by the demand control ventilation system 150 and/or deactivated based on wireless communication via network 130 in real-time as the air quality parameters deviate from the corresponding air quality parameter thresholds and/or are maintained within the corresponding air quality parameter thresholds.

Communication between the sensors 120(a-n), the controller 140, and the demand control ventilation system 150, and/or the air quality parameter server 160, may occur via wireless and/or wired connection communication. Wireless communication may occur via one or more networks 130 such as the internet or Wi-Fi wireless access points (WAP). In some embodiments, the network 130 may include one or more wide area networks (WAN) or local area networks (LAN). The network may utilize one or more network technologies such as Ethernet, Fast Ethernet, Gigabit Ethernet, virtual private network (VPN), remote VPN access, a variant of IEEE 802.11 standard such as Wi-Fi, and the like. Communication over the network 130 takes place using one or more network communication protocols including reliable streaming protocols such as transmission control protocol (TCP), Ethernet, Modbus, CanBus, EtherCAT, ProfiNET, and/or any other type of network communication protocol that will be apparent from those skilled in the relevant art(s) without departing from the spirit and scope of the present disclosure. Wired connection communication may occur but is not limited to a fiber optic connection, a coaxial cable connection, a copper cable connection, and/or any other type of direct wired connection that will be apparent from those skilled in the relevant art(s) without departing from the spirit and scope of the present disclosure. These examples are illustrative and not intended to limit the present disclosure.

### Parameter Monitoring and Control

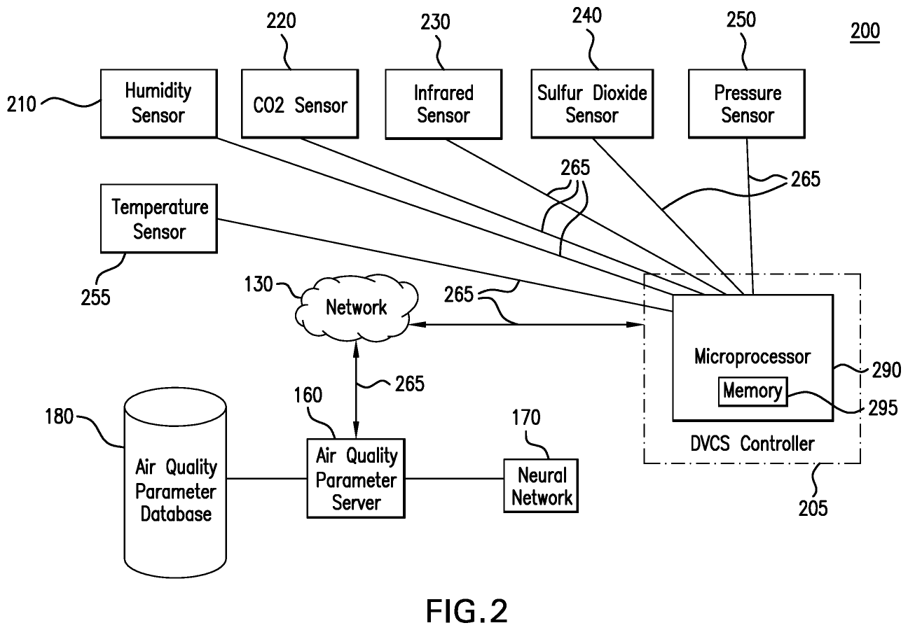

FIG. 2 illustrates a block diagram of demand control ventilation configuration 200 where the demand control ventilation system (DVCS) controller 205 monitors various air quality parameters associated with the current demand of the required ventilation of the building 110 based on the human activity of the occupants of the building 110. The DVCS controller 205 may then automatically activate graduated actions to be executed by the demand control ventilation system (DVCS) 150 in response to the monitored air quality parameters. In doing so, the DVCS controller 205 may continuously monitor the air quality parameters and activate the graduated actions to be executed by the DVCS 150 in real-time when necessary to maintain the air quality parameters within their corresponding air quality parameter thresholds to maintain the current demand of the required ventilation of the building 110 within the current demand threshold. The demand control ventilation configuration 200 shares many similar features with the demand control ventilation configuration 100; therefore, only the differences between the demand control ventilation configuration 200 and the demand control ventilation configuration 100 are to be discussed in further detail.

In one embodiment of the present disclosure, the DVCS controller 205 may connect and/or communicate via wireless communication 265 to one or more modules that when commands are received by the DVCS controller 205 a graduated action is activated based on the monitoring of air quality parameters by each of the modules to maintain the air quality parameters within the corresponding air quality parameter thresholds to maintain the current demand of the required ventilation within the current demand threshold demand control ventilation configuration 200. The one or more modules of the temperature sensor 225, the humidity sensor 210, the CO2 sensor 220, the infrared sensor 230, the sulfur dioxide sensor 240, the pressure sensor 250 and/or any other module that may monitor air quality parameters of the demand control ventilation configuration 200 to maintain the current demand of the required ventilation of the building to be within the current demand threshold that will be apparent to those skilled in the relevant art(s) without departing from the spirit and scope of the disclosure.

The DVCS controller 205 includes a microprocessor 290 and a memory 295 and may be referred to as a computing device or simply “computer”. For example, the DVCS controller 205 may be workstation, mobile device, computer, cluster of computers, remote cloud service, set-top box, or other computing device. In one embodiment of the present invention, multiple modules may be implemented on the same computing device. Such a computing device may include software, firmware, hardware, or a combination thereof. Software may include one or more applications on an operating system. Hardware can include, but is not to be limited to, the microprocessor 290 and/or the memory 295. The DVCS controller 205 may be in wireless communication with each of the temperature sensor 225, the humidity sensor 210, the CO2 sensor 220, the infrared sensor 230, the sulfur dioxide sensor 240, and the pressure sensor 250.

A plurality of temperature sensors 225 may include numerous temperature sensors 225 with each temperature sensor 225 positioned at different locations in the building 110. Each temperature sensor 225 may measure a temperature parameter that provides a corresponding level of heat present in the different locations in the building 110 and is indicative as to the current demand of the ventilation of the building 110 based on the level of heat present in different locations in the building 110.

The DVCS controller 205 may monitor the temperature parameter measured by each corresponding temperature sensor 225 to determine whether the temperature parameter exceeds a temperature parameter threshold. The temperature parameter threshold when exceeded is indicative that the level of heat for corresponding locations in the building 110 where the temperature parameter exceeds the temperature parameter threshold requires that the heat present be exhausted by the DVCS 150 to satisfy the current demand threshold of the ventilation of the building 110. The DVCS controller 205 may automatically adjust a plurality of fans included in the DVCS 150 for each corresponding location of the building 110 when the temperature parameter exceeds the temperature parameter threshold to exhaust the heat for each corresponding location of the building 110 to maintain the level of heat of each corresponding location of the building below the temperature parameter threshold. The automatic adjustment of the fans decreases the level of heat to below the temperature parameter threshold and prevents unnecessary energy consumption by the fans to decrease the level of heat to below the temperature parameter threshold.

For example, air within the building 110 that has a level of heat that exceeds the temperature parameter threshold may be air that requires exhaust from the building 110 by the DVCS 150 and replaced with cooler air from outside the building 110 if available. Such air with a level of heat that exceeds the temperature parameter threshold may be generated when a kitchen located inside the building 110 with appliances that when turned on may increase level of heat of the air in the kitchen to beyond the temperature parameter threshold. The DVCS controller 205 may then increase the fan speed of the fans of the DVCS 150 to exhaust the air with the level of heat that exceeds the temperature parameter threshold from the building 110 and replace with cooler air located outside the building 110. In doing so, the DVCS controller 205 may increase the fan speed of the fans to a capacity that is sufficient to remove the air with the level of heat that exceeds the temperature parameter threshold as caused by the kitchen appliances while maintaining such fan speed of the fans for a duration that corresponds to the kitchen appliances being activated and increasing the level of heat of the air in the kitchen beyond the temperature parameter threshold. After the kitchen appliances are no longer activated and increasing the level of heat of the air in the kitchen beyond the temperature parameter threshold, the DVCS controller 205 may reduce the fan speed of the fans thereby preventing any unnecessary energy consumption.

A plurality of humidity sensors 210 may include numerous humidity sensors 210 with each humidity sensor 210 positioned at different locations in the building 110. Each humidity sensor 210 may measure a humidity parameter that provides a corresponding level of humidity present in different locations in the building 110 and is indicative to the current demand of the ventilation of the building 110 based on the level of humidity present in different locations of the building 110.

The DVCS controller 205 may monitor the humidity parameter measured by each corresponding humidity sensor 210 to determine whether the humidity parameter exceeds a humidity parameter threshold. The humidity parameter threshold when exceeded is indicative that the level of moisture for corresponding locations in the building 110 where the humidity parameter exceeds the humidity parameter threshold requires that the moisture present be exhausted by the DVCS 150 to satisfy the current demand threshold of the ventilation of the building 110. The DVCS controller 205 may then adjust fans included in the DVCS 150 for each corresponding location of the building when the humidity parameter exceeds the humidity parameter threshold to exhaust the moisture for each corresponding location of the building 110 to maintain the level of moisture for each corresponding location of the building 110 below the humidity parameter threshold. The automatic adjustment of the fans deceases the level of humidity to below the humidity parameter threshold and prevents unnecessary energy consumption by the fans to decrease the level of moisture below the humidity parameter threshold.

For example, air within the building 110 that has a level of moisture that exceeds the humidity parameter threshold may be air that requires exhaust from the building 110 by the DVCS 150 and replaced with dryer air from outside the building 110 if available. Such air with a level of moisture that exceeds the humidity parameter threshold may be generated when a locker room located inside the building 110 with showers that when activated may increase the level of moisture of the air in the locker room to beyond the humidity parameter threshold. The DVCS controller 205 may then increase the fan speed of the fans of the DVCS 150 to exhaust the air with the level of moisture that exceeds the moisture parameter threshold from the building 110 and replace with dryer air located outside the building 110. In doing so, the DVCS controller 205 may increase the fan speed of the fans to a capacity that is sufficient to remove the air with the level of moisture that exceeds the humidity parameter threshold as caused by the showers while maintaining such fan speed of the fans for a duration that corresponds to the showers being activated and increasing the level of moisture of the air in the locker room beyond the humidity parameter threshold. After the showers are no longer activated and increasing the level of moisture of the air in the locker room beyond the moisture parameter threshold, the DVCS controller 205 may reduce the fan speed of the fans thereby preventing any unnecessary energy consumption.

A plurality of CO2 sensors 220 may include numerous CO2 sensors 220 with each CO2 sensor 220 positioned at different locations in the building 110. Each CO2 sensor 220 may measure a CO2 parameter that provides a corresponding level of CO2 present in different locations in the building 110 and is indicative to the current demand of the ventilation of the building 110 based on the level of CO2 present in different locations of the building 110.

The DVCS controller 205 may monitor the CO2 parameter measured by each corresponding CO2 sensor 220 to determine whether the CO2 parameter exceeds a CO2 parameter threshold. The CO2 parameter threshold when exceeded is indicative that the level of CO2 for corresponding locations in the building 110 where the CO2 parameter exceeds the CO2 parameter threshold requires that the CO2 present be exhausted by the DVCS 150 to satisfy the current demand threshold of the ventilation of the building 110. The DVCS controller 205 may adjust fans included in the DVCS 150 for each corresponding location of the building 110 when the CO2 parameter exceeds the CO2 parameter threshold to exhaust the CO2 for each corresponding location of the building to maintain the level of CO2 for each corresponding location of the building 110 below the CO2 parameter threshold. The automatic adjustment of the fans decreases the level of CO2 to below the CO2 parameter threshold and prevents unnecessary energy consumption by the fans to decrease the level of CO2 to below the CO2 parameter threshold.

For example, air within the building 110 that has a level of CO2 that exceeds the CO2 parameter threshold may be air that requires exhaust from the building 110 by the DVCS 150 and replaced with air with fresher air from outside the building 110 if available. Such air with a level of CO2 that exceeds the humidity parameter threshold may be generated when a conference room located inside the building 110 is occupied by several occupants that may increase the level of CO2 of the air in the conference room to beyond the CO2 parameter threshold. The DVCS controller 205 may then increase the fan speed of the fans of the DVCS 150 to exhaust the air with the level of CO2 that exceeds the CO2 parameter threshold from the building 110 and replace with fresher air located outside the building 110. In doing so, the DVCS controller 205 may increase the fan speed of the fans to a capacity that is sufficient to remove the air with the level of CO2 that exceeds the CO2 parameter threshold as caused by the occupied conference room while maintaining such fan speed of the fans for a duration that corresponds to the conference room being occupied by several occupants and increasing the level of CO2 of the air in the conference room beyond the CO2 parameter threshold. After the conference room is no longer occupied and increasing the level of CO2 of the air in the conference room beyond the CO2 parameter threshold, the DVCS controller 205 may reduce the fan speed of the fans thereby preventing any unnecessary energy consumption.

A plurality of infrared sensors 230 may include numerous infrared sensors 230 with each infrared sensor 230 positioned at different locations in the building 110. Each infrared sensor 230 may measure a person presence parameter that provides a corresponding level of people present in different locations in the building 110 and is indicative to the current demand of the ventilation of the building 110 based on the amount of people present in different locations of the building 110.

The DVCS controller 205 may monitor the person presence parameter measured by each corresponding infrared sensor 220 to determine whether the person presence parameter exceeds a person presence parameter threshold. The person presence parameter threshold when exceeded is indicative that the level of people present for corresponding locations in the building 110 where the person presence parameter exceeds the person presence parameter threshold requires that the exhaust by the DVCS 150 be increased to satisfy the current demand threshold of the ventilation of the building 110. The DVCS controller 205 may automatically adjust fans included in the DVCS 150 for each corresponding location of the building 110 when the person presence parameter exceeds the person presence parameter threshold to increase the exhaust by the DVCS 150 for each corresponding location to accommodate for the amount of people present for each corresponding location of the building 110. The automatic adjustment of the fans increases the exhaust of the DVCS 150 to accommodate the amount of people present in each corresponding location and prevents power unnecessary consumption the fans.

For example, amount of people in a location of the building 110 has an amount of people that exceeds the person presence parameter threshold thereby anticipating that air requires exhaust from the building 110 by the DVCS 150 and replaced with air with fresher air from outside the building 110 if available. Such an amount of people that exceeds the person presence parameter threshold may be generated when a bathroom located inside the building 110 is occupied by several occupants that may increase the amount odors in the air in the bathroom based on the amount of people exceeding the person presence parameter threshold. The infrared sensors 230 positioned in the bathroom may measure the motion of occupants that enter the bathroom and/or detect heat emitted from the occupants that enter the bathroom. In doing so, the infrared sensor 230 may measure the amount of occupants that are in the bathroom.

The DVCS controller 205 may then increase the fan speed of the fans of the DVCS 150 to exhaust the air with in the bathroom in anticipation that the odors in the bathroom requires such exhaust when the person presence parameter threshold in the bathroom is exceeded and replace with fresher air located outside the building 110. In doing so, the DVCS controller 205 may increase the fan speed of the fans to a capacity that is sufficient to remove the odors from the air in the bathroom when the person presence parameter threshold is exceeded by the amount of occupants in the bathroom while maintaining such fan speed of the fans for a duration that corresponds to the bathroom being occupied by several occupants in anticipation of an increase the odors of the air in the bathroom due to the person presence parameter threshold being exceeded. After the bathroom is no longer occupied and increasing the odors in the air in the bathroom when the person presence parameter threshold is exceeded, the DVCS controller 205 may reduce the fan speed of the fans thereby preventing any unnecessary energy consumption.

A plurality of sulfur dioxide sensors 240 may include numerous sulfur dioxide sensors 240 with each sulfur dioxide sensor 240 positioned at different locations in the building 110. Each sulfur dioxide sensor 240 may measure a sulfur dioxide parameter that provides a corresponding level of sulfur dioxide present in different locations in the building 110 and is indicative to the current demand of the ventilation of the building 110 based on the level of odors present in different locations of the building 110.

The DVCS controller 205 may monitor the sulfur dioxide parameter measured by each corresponding sulfur dioxide sensor 240 to determine whether the sulfur dioxide parameter exceeds a sulfur dioxide parameter threshold. The sulfur dioxide parameter threshold when exceeded is indicative that the level of odors for corresponding locations in the building 110 where the sulfur dioxide parameter exceeds the sulfur dioxide parameter threshold requires that the odors present be exhausted by the DVCS 150 to satisfy the current demand threshold of the ventilation of the building 110. The DVCS controller 205 may adjust fans included in the DVCS 150 for each corresponding location of the building 110 when the sulfur dioxide parameter exceeds the sulfur dioxide parameter threshold to exhaust the odors for each corresponding location of the building to maintain the level of odors for each corresponding location of the building 110 below the sulfur dioxide parameter threshold. The automatic adjustment of the fans decreases the level of odors to below the sulfur dioxide parameter threshold and prevents unnecessary energy consumption by the fans to decrease the level of odors to below the sulfur dioxide parameter threshold.

For example, air within the building 110 that has a level of odors that exceeds the sulfur dioxide parameter threshold may be air that requires exhaust from the building 110 by the DVCS 150 and replaced with fresher air from outside the building 110 if available. Such air with a level of odors that exceeds the sulfur dioxide parameter threshold may be generated when a bathroom located inside the building 110 is occupied by several occupants that may be increase the level of odors of the air in the bathroom to beyond the sulfur dioxide parameter threshold. The DVCS controller 205 may then increase the fan speed of the fans of the DVCS 150 to exhaust the air with the level of odors that exceeds the sulfur dioxide parameter threshold from the building 110 and replace with fresher air located outside the building 110. In doing so, the DVCS controller 205 may increase the fan speed of the fans to a capacity that is sufficient to remove the air with the level of odors that exceeds the sulfur dioxide parameter threshold as caused by the occupied bathroom while maintaining such fan speed of the fans for a duration that corresponds to the level of odors generated by the occupants of the bathroom and increasing the level of odors of the air in the bathroom beyond the sulfur dioxide parameter threshold. After the bathroom is no longer occupied by occupants generated levels of odors that exceed the sulfur dioxide parameter threshold of the air in the bathroom, the DVCS controller 205 may reduce the fan speed of the fans thereby preventing any unnecessary energy consumption.

A plurality of pressure sensors 250 may include numerous pressure sensors 250 with each pressure sensor 250 positioned at different locations in the building 110 as well as outside the building 110. Each pressure sensor 250 may measure a pressure parameter that provides a corresponding difference in pressure between different locations in the building 110 as well as outside the building 110. The level of pressure difference between different locations in the building 110 as well as outside the building 110 that when exceeds a pressure differential threshold is indicative exhaust volumes of air exhausted from the building 110 and the fresh volumes of air ventilated into the building 110 is to be adjusted by the DVCS 150 to maintain the pressure throughout the different locations in the building 110 as well as outside the building 110 to maintain the level of pressure differential to be below the pressure differential threshold.

The DVCS controller 205 may monitor the pressure parameter measured by each corresponding pressure sensor 250 to determine whether the pressure parameter exceeds a pressure differential threshold. The pressure differential threshold when exceeded is indicative that the level of pressure differential for corresponding locations in the building 110 as well as outside of the building 110 where the pressure parameter exceeds the pressure differential threshold requires that the exhaust volumes of the air exhausted from the building 110 and the fresh volumes of air ventilated into the building 110 is to be adjusted by the DVCS 150 to maintain the pressure throughout the different locations in the building 110 as well as outside the building 110 to maintain the level of pressure differential to be below the pressure differential threshold. The DVCS controller 205 may activate the DVCS 150 to adjust exhaust volumes of the air exhausted from the building 110 and the fresh volumes of air ventilated into the building 110 to maintain the pressure throughout the different locations in the building 110 as well as outside the building 110 to maintain the level of pressure differential to be below the pressure differential threshold. The automatic adjustment of the exhaust volumes of air exhausted from the building 110 and the fresh volumes of air ventilated into the building 110 maintains the level of pressure differential to be below the pressure differential and prevents unnecessary energy consumption by the DVCS 150 to maintain the level of pressure differential to below the pressure differential threshold.

In an embodiment, the DVCS 150 may include an economizer that determines when to supply an increase in fresh air from outside the building 110 when the building 110 is required to be cooled and the temperature of the fresh air from outside the building 110 is sufficient to cool the building 110. In doing so, energy consumption may be decreased by not having to condition the air inside the building 110 to cool the air inside the building 110 but rather ventilate in the fresh air from outside the building 110 that is already cooled. However, often times, the pressure of inside the building may significantly increase when the air inside the building is not sufficiently exhausted to correspond to the amount of fresh air from outside the building 110 that is being ventilated inside the building 110 due to the cooled temperature of the air outside the building 110 to cool the temperature inside the building 110. Further, the level of CO2 of the air inside the building 110 may significantly increase when the fresh air outside the building 110 is being ventilated inside the building 110 but the fresh air is actually contaminated with CO2 from the outside environment of the building, such as traffic from a busy street.

In such an embodiment, the DVCS controller 205 may monitor the level of pressure differential as well as the level of CO2 inside the building 110 when the economizer is ventilating fresh air from outside the building 110 to inside the building 110 to cool the temperature of the inside of the building 110. When the level of pressure differential between inside the building 110 and outside the building increases beyond the pressure differential threshold and/or the level of CO2 of the air inside the building exceeds the CO2 parameter threshold, the DVCS controller 205 may deactivate the economizer of the DVCS 150 and deactivate the ventilation of fresh air from outside the building 110 to cool the temperature of inside the building 110.

Returning to FIG. 1, as the controller 140 monitors each of the air quality parameters measured by the sensors 120(a-m) of the to determine whether the air quality parameters deviate from the corresponding air quality parameter thresholds and as the controller 120 automatically adjusts the DVCS 150 to maintain the air quality parameters within the air quality parameter thresholds, the controller 120 may stream air quality parameter data to an air quality parameter server 160 that is stored in an air quality parameter database 180. Air quality parameter data is any type of data that is associated with the air quality parameters of the building 110 as well as with the controller 120 monitoring the air quality parameters of the building 110 as well as with the adjustments to the air quality parameters that the controller 120 may execute to ensure the air quality parameters remain within the corresponding air quality parameter thresholds. Thus, the air quality parameter data is any type of data associated with the air quality of the building 110 that may impact the current demand required of the ventilation of the building 110 whether positively and/or negatively that may be incorporated in the future by the controller 120 and/or any other controller associated with any other DVCS to assist the controller 120 and/or any other controller in automatically adjusting the air quality parameters to ensure the air quality parameters remain within the corresponding air quality parameter thresholds.

For example, the DVCS 150 may be equipped with a button and/or switch that when activated may automatically exhaust and ventilate fresh air to operate at 100% capacity for a programmable period of time such as but not limited to 5 minutes, 10 minutes, 15 minutes and so on. In another example, the controller 120 may determine when the DVCS 150 is struggling to maintain specific air quality parameters within the corresponding air quality parameter thresholds when the air quality parameters reach a certain magnitude. For example, the controller 120 may determine when the DVCS 150 struggles to decrease the level of CO2 to below the CO2 threshold when the level of CO2 approaches 850 ppm. The controller 120 may then capture the air quality parameter data associated with when the user manually activates the exhaust and ventilation of fresh air to operate at 100% capacity and may stream such air quality parameter data to the air quality parameter server 160 and store in the air quality parameter database 180. The controller 140 may also capture the air quality parameter data associated with air quality parameters that reach a certain magnitude and cause the DVCS 150 to maintain the air quality parameters within the air quality parameter threshold when such magnitudes in the air quality parameters reached and may stream such air quality parameter data to the air quality parameter server 160 and store in the air quality parameter database 180.

The controller 140 as well as any other controller associated with any other DVCS may continuously stream air quality parameter data to the air quality parameter server 160 that is stored on the air quality parameter database 180. In doing so, the air quality parameter database 180 may continuously accumulate air quality parameter data that is associated with automatic adjustments many different air quality parameters executed by many different controllers monitoring the air quality parameters with many different DVCSs. Over time as the air quality parameter data accumulated by the air quality parameter server 160 continues to increase, the neural network 170 may then apply a neural network algorithm such as but not limited to a multilayer perceptron (MLP), a restricted Boltzmann Machine (RBM), a convolution neural network (CNN), and/or any other neural network algorithm that will be apparent to those skilled in the relevant art(s) without departing from the spirit and scope of the disclosure.

Each time that air quality data is streamed to the air quality parameter server 170 and stored on the air quality parameter database 180, the neural network 170 may then assist the controller 120 by providing the controller 120 with the appropriate adjustments with regard to the appropriate air quality parameters to automatically adjust the DVCS 150 in anticipation of the DVCS 150 to head off any air quality parameter deviation of the corresponding air quality parameter thresholds as the air quality parameters begin to behave in certain manner based on the air quality parameters of the DVCS 150 based on the increased amount of air quality parameter data stored in the air quality parameter database 180. The neural network 170 may assist the controller 140 in learning as to the appropriate actions to execute based on the air quality parameters that the building 110 is experiencing such that the neural network 170 may further improve the accuracy of the controller 140 in automatically adjusting the appropriate air quality parameters to further enhance the current demand of the required ventilation of the building 110 in real-time. The neural network 170 may provide the controller 140 with improved upon accuracy in automatically adjusting the appropriate air quality parameters such that the neural network 170 may continue to learn upon with the accumulation of air quality parameter data that is provided by the controller 140 and/or any other controller associated with any other DVCS to the air quality parameter server 160. Thus, the current demand required of the ventilation of the building 110 may be further enhanced.

### Conclusion

It is to be appreciated that the Detailed Description section, and not the Abstract section, is intended to be used to interpret the claims. The Abstract section may set forth one or more, but not all exemplary embodiments, of the present disclosure, and thus, is not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) the various changes in form and detail can be made without departing from the spirt and scope of the present disclosure. Thus the present disclosure should not be limited by any of the above-described exemplary embodiments, but should be defined only in accordance with the following claims and their equivalents.

What is claimed is:

1. A demand control ventilation system that automatically adjusts ventilation of a building based on a plurality of air quality parameters that are monitored throughout the building; comprising:
a plurality of sensors positioned in the building with each sensor configured to measure a corresponding air quality parameter that each sensor is capable of measuring, wherein each air quality parameter is indicative as to a current demand required of the ventilation of the building based on human activity conducted by occupants present in the building; and
a controller configured to:
monitor each air quality parameter measured by each corresponding sensor to determine whether at least one air quality parameter deviates beyond at least one corresponding air quality parameter threshold, and
activate at least one graduated action when each air quality parameter deviates beyond the at least one corresponding air quality parameter threshold to automatically adjust the ventilation of the building to maintain the current demand of the ventilation within a current demand threshold, wherein the current demand threshold is a ventilation level of the ventilation of the building that satisfies the current demand based on human activity and prevents unnecessary energy consumption to satisfy the current demand.

2. The demand control ventilation system of claim 1, wherein the controller is further configured to:
refrain from activating each graduated action when each corresponding air quality parameter is maintained within the corresponding air quality parameter threshold to prevent the graduated action from being activated when the current demand required of the ventilation of the building does not require the activation of each graduated action to maintain the current demand of the ventilation within the current demand threshold thereby preventing unnecessary energy consumption to satisfy the current demand.

3. The demand control ventilation system of claim 2, wherein the controller is further configured to:
activate each graduated action when each corresponding parameter deviates beyond the corresponding air quality parameter threshold and maintain each graduated action in a deactivated state when each corresponding parameter that is maintained within the corresponding air quality parameter threshold to limit activation of each graduated action to each graduated action required to maintain the current demand of the ventilation within the current demand threshold and to prevent unnecessary energy consumption by unnecessary activation of graduated actions.

4. The demand control ventilation system of claim 3, further comprising:
a plurality of temperature sensors included in the plurality of sensors with each temperature sensor positioned at different locations in the building and configured to measure a temperature parameter that provides a corresponding level of heat present in different locations in the building and is indicative as to the current demand of the ventilation of the building based on the level of heat present in different locations in the building.

5. The demand control ventilation system of claim 4, wherein the controller is further configured to:
monitor the temperature parameter measured by each corresponding temperature sensor to determine whether the temperature parameter exceeds a temperature parameter threshold, wherein the temperature parameter threshold when exceeded is indicative that the level of heat for corresponding locations in the building where the temperature parameter exceeds the temperature parameter threshold requires that the heat present be exhausted by the ventilation system to satisfy the current demand threshold of the ventilation of the building;
automatically adjust a plurality of fans included in the demand control ventilation system for each corresponding location of the building when the temperature parameter exceeds the temperature parameter threshold to exhaust the heat for each corresponding location of the building to maintain the level of heat of each corresponding location of the building below the temperature parameter threshold, wherein the automatic adjustment of the fans decreases the level of heat to below the temperature parameter threshold and prevents unnecessary energy consumption by the plurality of fans to decrease the level of heat to below the temperature parameter threshold.

6. The demand control ventilation system of claim 3, further comprising:
a plurality of humidity sensors included in the plurality of sensors with each humidity sensor positioned at different locations in the building and configured to measure a humidity parameter that provides a corresponding level of humidity present in different locations in the building and is indicative to the current demand of the ventilation of the building based on the level of humidity present in different locations in the building.

7. The demand control ventilation system of claim 6, wherein the controller is further configured to:
monitor the humidity parameter measured by each corresponding humidity sensor to determine whether the humidity parameter exceeds a humidity parameter threshold, wherein the humidity parameter threshold when exceeded is indicative that the level of moisture for corresponding locations in the building where the humidity parameter exceeds the humidity parameter threshold requires that the moisture present be exhausted by the ventilation system to satisfy the current demand threshold of the ventilation of the building; and
automatically adjust a plurality of fans included in the demand control ventilation system for each corresponding location of the building when the humidity parameter exceeds the humidity parameter threshold to exhaust the moisture for each corresponding location of the building to maintain the level of moisture of each corresponding location of the building below the humidity parameter threshold, wherein the automatic adjustment of the fans decreases the level of humidity to below the humidity parameter threshold and prevents unnecessary energy consumption by the fans to decrease the level of moisture to below the humidity parameter threshold.

8. The demand control ventilation system of claim 3, further comprising:
a plurality of CO2 sensors included in the plurality of sensors with each CO2 sensor positioned at different locations in the building and configured to measure a CO2 parameter that provides a corresponding level of CO2 present in different locations in the building and is indicative to the current demand of the ventilation of the building based on a level of CO2 present in different locations in the building.

9. The demand control ventilation system of claim 8, further comprising:
monitor the CO2 parameter measured by each corresponding CO2 sensor to determine whether the CO2 parameter exceeds a CO2 parameter threshold, wherein the CO2 parameter threshold when exceeded is indicative that the level of CO2 for corresponding locations in the building where the CO2 parameter exceeds the CO2 parameter threshold requires that the CO2 present be exhausted by the ventilation system to satisfy the current demand threshold of the ventilation of the building; and
automatically adjust a plurality of fans included in the demand control ventilation system for each corresponding location of the building when the CO2 parameter exceeds the CO2 parameter threshold to exhaust the CO2 for each corresponding location of the building to maintain the level of CO2 for each corresponding location of the building below the CO2 parameter threshold, wherein the automatic adjustment of the fans decreases the level of CO2 to below the CO2 parameter threshold and prevents unnecessary energy consumption by the fans to decrease the level of CO2 to below the CO2 parameter threshold.

10. The demand control ventilation system of claim 3, further comprising:
a plurality of infrared sensors included in the plurality of sensors with each infrared sensor positioned at different locations in the building and configured to measure a person presence parameter that provides a corresponding level of people present in different locations in the building as indicative to the current demand of ventilation of the building based on an amount of people present in different locations of the building.

11. The demand control ventilation system of claim 10, wherein the controller is further configured to:
monitor the person presence parameter measured by each corresponding infrared sensor to determine whether the person presence parameter exceeds the person presence parameter threshold, wherein the person presence parameter threshold when exceeded is indicative that the amount of people present in corresponding locations in the building where the person presence parameter exceeds the person presence threshold requires that the exhaust by the ventilation system be increased to satisfy the current demand threshold of the ventilation of the building; and
automatically adjust a plurality of fans included in the demand control ventilation system for each corresponding location of the building when the person presence parameter exceeds the person presence parameter threshold to increase the exhaust by the ventilation system for each corresponding location to accommodate for the amount of people present for each corresponding location of the building, wherein the automatic adjustment of the fans increases the exhaust of the ventilation system to accommodate for the amount of people present in each corresponding location and prevents unnecessary energy consumption by the fans.

12. A method for a demand control ventilation system that automatically adjusts ventilation of a building based on a plurality of air quality parameters that are monitored throughout the building, comprising:
measuring by a plurality of sensors positioned in the building a corresponding air quality parameter that each sensor is capable of measuring, wherein each air quality parameter is indicative as to a current demand required of the ventilation of the building based on human activity conducted by occupants present in the building;
monitoring by a controller each air quality parameter measured by each corresponding sensor to determine whether at least one air quality parameter deviates beyond at least one corresponding air quality parameter threshold; and
activating at least one graduated action when each air quality parameter deviates beyond the at least one corresponding air quality parameter threshold to automatically adjust the ventilation of the building to maintain the current demand of the ventilation within a current demand threshold, wherein the current demand threshold is a ventilation level of the ventilation of the building that satisfies the current demand based on human activity and prevents unnecessary energy consumption to satisfy the current demand.

13. The method of claim 12, wherein the activating comprises:
refraining from activating each graduated action when each corresponding air quality parameter is maintained within the corresponding air quality parameter threshold to prevent the graduated action from being activated when the current demand required of the ventilation of the building does not require the activation of each graduated action to maintain the current demand of the ventilation within the current demand threshold thereby preventing unnecessary energy consumption to satisfy the current demand.

14. The method of claim 13, wherein the activating further comprises:
activating each graduated action when each corresponding parameter deviates beyond the corresponding air quality parameter threshold and maintain each graduated action in a deactivated state when each corresponding parameter that is maintained with the corresponding air quality parameter threshold to limit activation of each graduated action to each graduated action to maintain the current demand of the ventilation system within the current demand threshold and to prevent unnecessary energy consumption by unnecessary activation of graduated actions.

15. The method of claim 14, further comprising:
measuring by a plurality of temperature sensors a temperature parameter that provides a corresponding level of heat present in different locations in the building and is indicative as to the current demand of the ventilation of the building based on the level of heat present in different locations in the building.

16. The method of claim 15, further comprising:
monitoring by the controller the temperature parameter measured by each corresponding temperature sensor to determine whether the temperature parameter exceeds a temperature parameter threshold, wherein the temperature parameter threshold when exceeded is indicative that the level of heat for corresponding locations in the building where the temperature parameter exceeds the temperature parameter threshold requires that the heat present be exhausted by the ventilation system to satisfy the current demand threshold of the ventilation of the building; and
automatically adjust a plurality of fans included in the demand control ventilation system for each corresponding location of the building when the temperature parameter exceeds the temperature parameter threshold to exhaust the heat for each corresponding location of the building to maintain the level of heat of each corresponding location of the building below the temperature parameter threshold, wherein the automatic adjustment of the fans decreases the level of heat to below the temperature parameter threshold and prevents unnecessary energy consumption by the plurality fans to decease the level of heat to below the temperature parameter threshold.

17. The method of claim 14, further comprising:
measuring by a plurality of humidity sensors a humidity parameter that provides a corresponding level of humidity present in different locations in the building and is indicative to the current demand of the ventilation of the building based on the level of humidity present in different locations in the building.

18. The method of claim 17, further comprising:
monitoring by the controller the humidity parameter measured by each corresponding humidity sensor to determine whether the humidity parameter exceeds a humidity parameter threshold, wherein the humidity parameter threshold when exceeded is indicative that the level of moisture for corresponding locations in the building where the humidity parameter exceeds the humidity parameter threshold requires that the moisture present be exhausted by the ventilation system to satisfy the current demand threshold of the ventilation of the building; and
automatically adjusting a plurality of fans included in the demand control ventilation system for each corresponding location of the building when the humidity parameter exceeds the humidity parameter threshold to exhaust the moisture for each corresponding location of the building to maintain the level of moisture of each corresponding location of the building below the humidity parameter threshold, wherein the automatic adjustment of the fans decreases the level of humidity to below the humidity parameter threshold and prevents unnecessary energy consumption by the fans to decrease the level of moisture to below the humidity parameter threshold.

19. The method of claim 14, further comprising:
measuring by a plurality of CO2 sensors a CO2 parameter that provides a corresponding level of CO2 present in different locations in the building and is indicative to the current demand of the ventilation of the building based on a level of CO2 present in different locations in the building.

20. The method of claim 19, further comprising:
monitoring by the controller the CO2 parameter measured by each corresponding CO2 sensor to determine whether the CO2 parameter exceeds a CO2 parameter threshold, wherein the CO2 parameter threshold when exceeded is indicative that the level of CO2 for corresponding locations in the building where the CO2 parameter exceeds the CO2 parameter threshold requires that the CO2 be exhausted by the ventilation system to satisfy the current demand threshold of the ventilation of the building; and
automatically adjusting a plurality of fans in the demand control ventilation system for each corresponding location of the building when the CO2 parameter exceeds the CO2 parameter threshold to exhaust the CO2 for each corresponding location of the building to maintain the level of CO2 for each corresponding location of the building below the CO2 parameter threshold, wherein the automatic adjustment of the fans decreases the level of CO2 to below the CO2 parameter threshold and prevents unnecessary energy consumption by the fans to decrease the level of CO2 to below the CO2 parameter threshold.

21. The method of claim 14, further comprising:
measuring by a plurality of infrared sensors a person presence that provides a corresponding level of people present in different locations in the building as indicative to the current demand of ventilation of the building based on an amount of people present in different locations of the building.

22. The method of claim 21, further comprising:
monitoring by the controller the person presence parameter measured by each corresponding infrared sensor to determine whether the person presence parameter exceeds the person presence parameter threshold, wherein the person presence parameter threshold when exceeded is indicative that the amount of people present in corresponding locations in the building where the person presence parameter exceeds the person presence threshold requires that the exhaust by the ventilation system be increased to satisfy the current demand threshold of the ventilation of the building; and
automatically adjusting a plurality of fans included in the demand control ventilation system for each corresponding location of the building when the person presence parameter exceeds the person presence parameter threshold to increase the exhaust by the ventilation system for each corresponding location to accommodate for the amount of people present for each corresponding location of the building, wherein the automatic adjustment of the fans increases the exhaust of the ventilation system to accommodate for the amount of people present in each corresponding location and prevents unnecessary consumption by the fans.
